(19) United States
(12) Patent Application Publication
(10) Pub. No.: US 2010/0243410 A1
(43) Pub. Date: Sep. 30, 2010

(54) Method and apparatus for cleaning and sanitizing conveyor belts

(75) Inventors: William S. Hall, Lexington, OH (US); Nathaniel A. Lowe, Kenton, OH (US); Mark F. Haushalter, Bellefontaine, OH (US)

Correspondence Address: Law Office of Barbara Joan Haushalter, 228 Bent Pines Court, Bellefontaine, OH, 43311, US

(73) Assignee: H & H Green,LLC

(21) Appl. No.: 12/383,898

(22) Filed: Mar. 30, 2009

(51) Int. Cl. B65G 45/22

(52) U.S. Cl. 198/495

(57) ABSTRACT

A conveyor belt cleaning and sanitizing apparatus includes a hollow porous roller situated on the obscured or return loop side of the conveyor belt, out of sight of the top or conveying surface of the belt. A perforated rod, positioned within the hollow porous roller, contains a cleaning and sanitizing solution, dispensable through a series of perforations in the rod. The cleaning and sanitizing solution is evenly distributed to the porous roller and dispensed outwardly through the hollow porous roller to remove any debris and bacteria from the conveyor belt without excess solution. The cleaning and sanitizing solution can be inserted in the perforated rod using a pump from a tank reservoir. The pumping system is capable of metering the amount of fluid for application to the belt, based on usage of the belt. A tray can be situated below the hollow porous roller to contain debris and fluids removed from the conveyor belt surface.

### BACKGROUND OF THE INVENTION

The present invention relates to the field of cleaning and sanitizing the conveying surface of a conveyor belt and, more particularly, to the cleaning and sanitizing of continuous conveyor belt surfaces. The present invention is particularly, though not exclusively, well suited for use in cleaning and sanitizing the contact surfaces of conveyor belts in a typical grocery store checkout.

In the grocery store industry, it has become more and more necessary to provide customers with quick, and efficient customer service and checkout, with particular emphasis on quickly moving customers through checkout lines as fast as possible. In order to expedite the check-out process, a number of label and bar code scanning device have been implemented that can, with the swipe of a cashier's hand, read the label and determine the product category, description and price. In order to further expedite the checkout process, checkout stands have been equipped with various mechanisms for bringing the products to the cashier. One such mechanism is a linear, conveyor-belt check stand. The conveyor-belt check stand is very efficient in advancing groceries toward the cashier. In particular, since the conveyor belt is a long device, ranging from a few to several feet long, it provides an advancing conveyor surface, allowing the customer to quickly deposit most, if not all, of their selected items on the conveyor. The items are then advanced directly toward the cashier's label-scanning device. As a result of these various advantages, the linear conveyor-belt check stand has become the most widely used check stand in the grocery industry.

In a conveyor-belt type check stand, a synthetic conveyor belt, typically of rubber or plastic, is supported on each end by a roller. These rollers provide a tension between themselves to retain the conveyor belt in position. The belt is also equipped with a drive motor that advances the belt around the rollers. In use, a customer approaches a check stand and places his groceries on the conveyor belt. Either by manual control or by an automated device, the rollers begin to rotate, thereby advancing the surface of the conveyor belt containing the groceries toward the cashier.

One of the many challenges for cashiers is the maintenance of the conveyor belt. The cashier must ensure that the conveyor belt is kept clean, and make sure that his customers have a clean place to set their groceries. Grocery stores carry a wide variety of products, including fresh and frozen vegetables, containers of milk and ice cream, fresh fish, poultry, and beef, along with all household cleaning solutions and chemicals, such as soaps and bleach. Despite significant improvements in product packaging it is a fact that many products still leak fluids. Loose wrapping may allow leaks on the belt, such as the juices from raw meats. Also, frozen products may start to melt, causing condensation on the belt. Or, a plastic bottle with a loose lid, may leave sticky fluids on the conveyor belt. Since the fluids and debris left on the conveyor belt may be from uncooked meat, poultry, fish, or perhaps a leaky bleach or lye bottle, it is clear that these fluid and debris remnants can cause significant health and safety concerns to both the customer and the cashier.

Because of these concerns, it is routine for a cashier to have a bottle of cleaner and/or disinfectant at his station. Armed with a roll of paper towels, it is standard practice for the cashier to periodically pause and spray disinfectant on a smudge, smear or collection of unknown substance on the conveyor belt and wipe it clean with the paper towels. Unfortunately, when there is a long line of anxious customers, or there are no more towels or disinfectant solution available to the cashier, it is possible that the conveyor belt is not cleaned often enough. This is particularly troubling when considering the types of fluids that may exist on the surface of a grocery store check stand, such as harsh chemicals like bleach and lye, and uncooked food drippings laced with bacteria such as Escherichia coli (E-coli), Salmonella, and assorted viruses and fungi.

Although some automatic cleaning systems for conveyor belts have been attempted, these existing systems often involve a spray that dispenses directly on the belt, wasting fluid. Additionally, existing systems dispense fluid whereby the belt returns to the top or conveying surface all wet, which is almost as undesirable to patrons as an unclean surface.

In light of the above, it would be advantageous to provide a solution to the cashier's routine task of cleaning the check stand conveyor belt. It would also be advantageous to provide a cleaning device that automatically cleans the conveyor belt without any action by the cashier as he is often too busy or distracted to remember to do it. It would be a further advantage to provide a system whereby the conveying surface is clean, sanitized, and dry when it returns to the top of the continuous loop. It is also advantageous to provide a device that may be incorporated into new check stands, as well as be easily retrofitted into existing check stands. Finally, it would be advantageous to provide a device that is easy to manufacture, easy to install, and easy to maintain, yet is still cost effective.

### SUMMARY OF THE INVENTION

This need is met by the conveyor belt cleaning and sanitizing apparatus of the present invention, wherein the apparatus is stationed underneath a grocery store continuous loop conveyor belt to clean and sanitize the belt as it rolls under the check area.

In accordance with one aspect of the present invention, a hollow porous roller is situated on the obscured or return loop side of the conveyor belt, out of sight of the top or conveying surface of the belt. A perforated rod is positioned within the hollow porous roller. The perforated rod is filled with a cleaning and sanitizing solution, dispensable through a series of perforations in the rod, allowing for even distribution of the solution outwardly through the roller material to clean and sanitize the conveyor belt surface. The cleaning and sanitizing solution is dispensed along the length of the hollow porous roller, whereby the hollow porous roller cleans and sanitizes the conveyor belt without any excess fluid drip. The cleaning and sanitizing solution can be inserted in the perforated rod using a pump from a tank reservoir. The pumping system is capable of metering the amount of fluid for application to the belt, based on usage of the belt. A tray can be situated below the hollow porous roller to contain debris and fluids removed from the conveyor belt surface. A drying roller can be positioned to contact the surface of the conveyor belt to expedite drying of the belt surface.

Accordingly, it is an object of the present invention to provide a means for routine and continuous cleaning of the check stand conveyor belt. It is also an object of the present invention to provide such a cleaning device that automatically cleans the conveyor belt without any action by the cashier. The system provides for an even and accurate distribution of fluid, preventing excess fluid and waste. It is an advantage of the present invention that the apparatus may be incorporated into new check stands, as well as be easily retrofitted into existing check stands. Finally, it is an advantage of the present invention that it is easy to manufacture, easy to install, and easy to maintain, yet is still cost effective.

Other objects and advantages of the invention will be apparent from the following description, the accompanying drawing and the appended claims.

### BRIEF DESCRIPTION OF THE DRAWINGS

FIG. 1 illustrates a side view of the conveyor belt cleaning and sanitizing apparatus of the present invention with particular application on a grocery store continuous loop conveyor belt;

FIG. 2 illustrates an end view of the conveyor belt cleaning and sanitizing apparatus illustrated in FIG. 1;

FIG. 3 illustrates greater detail of the hollow porous roller and perforated rod, illustrated in FIGS. 1 and 2; and

FIGS. 4A and 4B illustrate bottom views of the conveyor belt and portions of the cleaning and sanitizing apparatus.

### DETAILED DESCRIPTION OF THE PREFERRED EMBODIMENTS

The present invention provides for a system and method for cleaning and sanitizing a conveyor belt, and is particularly applicable for use with a continuous loop conveyor belt such as is used in many grocery stores. The present invention is designed to be contained in the underside region of the conveyor belt, to clean and sanitize the belt as it passes below the conveying surface in its continuous loop cycle. Each time the conveying surface returns to the top side, it has been cleaned and sanitized.

In accordance with the teachings of the present invention, activation of the conveyor belt will cause a cleaning and sanitizing solution to treat a porous roller that will roll across the belt. A drying roller can be disposed thereafter to expedite drying of the conveyor belt. While a preferred embodiment of the present invention described herein proposes providing the cleaning and sanitizing solution from a reservoir to a hollow interior of the porous roller where it can be wicked out the roller material to contact the belt, a number of alternative embodiments can be envisioned without departing from the scope of the invention.

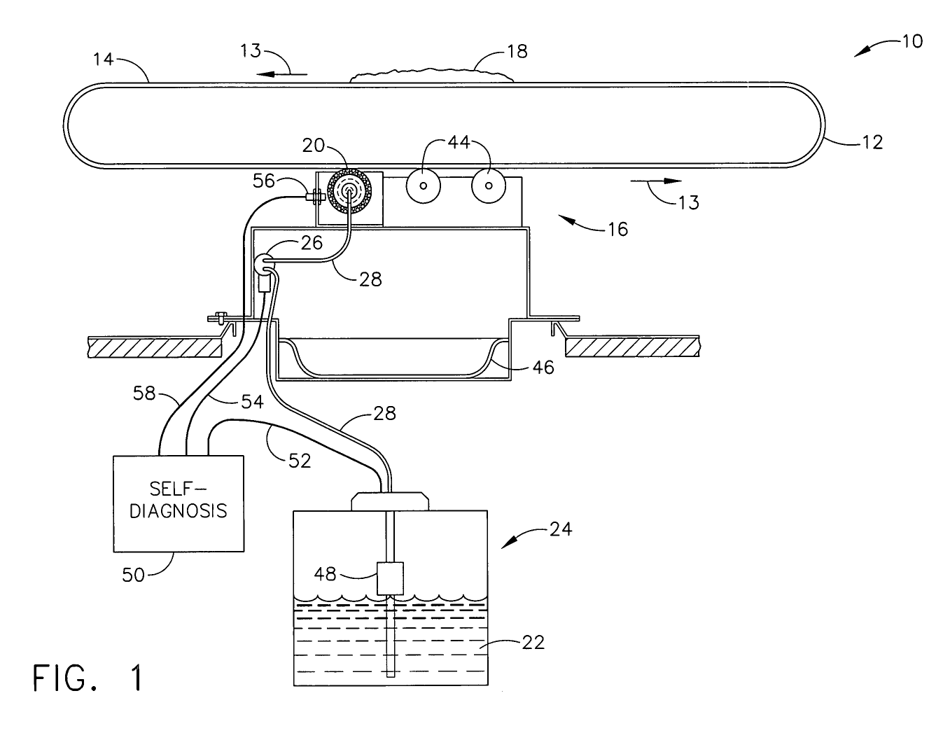

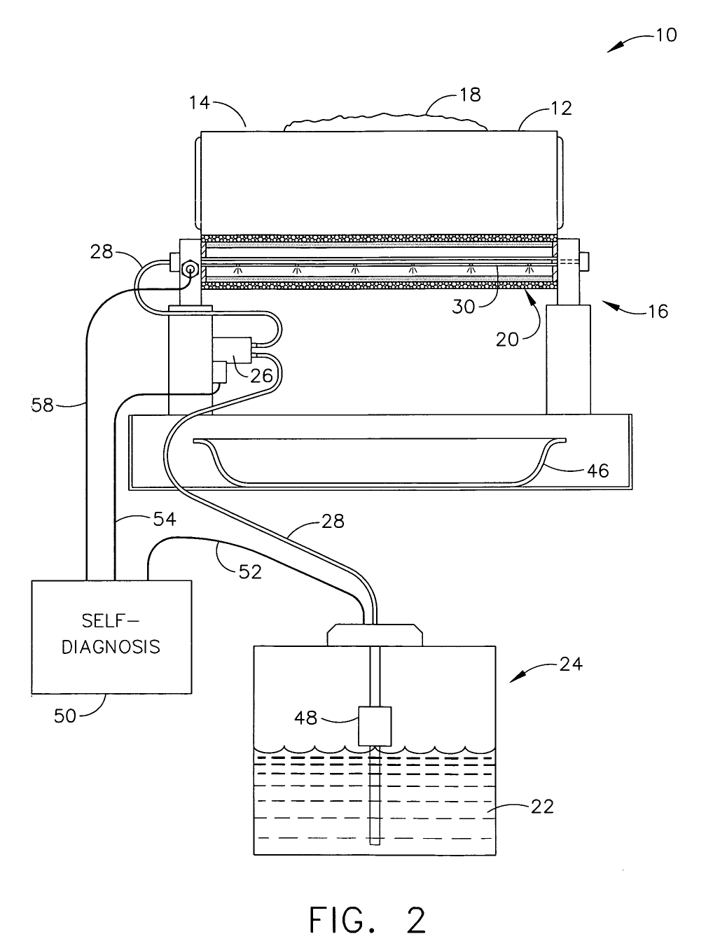

Referring now to FIGS. 1 and 2, there is illustrated the cleaning and sanitizing system 10 of the present invention. In accordance with the present invention, a continuous loop conveyor belt 12 such as would be in a grocery store, receives items for transport to a check stand, as it travels in the direction of arrows 13. The continuous loop conveyor belt 12 will typically have an exposed surface 14 for receiving and transporting items to the check stand, and an obscured surface region 16 when the conveyor belt loops back around, usually below the transporting surface 14.

During transport, some items may leave behind debris or leak fluid, as indicated by reference number 18 in FIGS. 1 and 2. The present invention removes debris, spills, germs and bacteria from the belt using a roller and pump combination. A hollow porous roller 20 is disposed in the obscured surface region 16 for providing debris removal and sanitization to the obscured surface. The roller 20 contacts the belt with a cleaning and sanitizing solution 22, contained in a reservoir or tank 24. The solution 22 is collected from the tank 24 by a pump 26, and provided to the roller 20 via fluid lines 28.

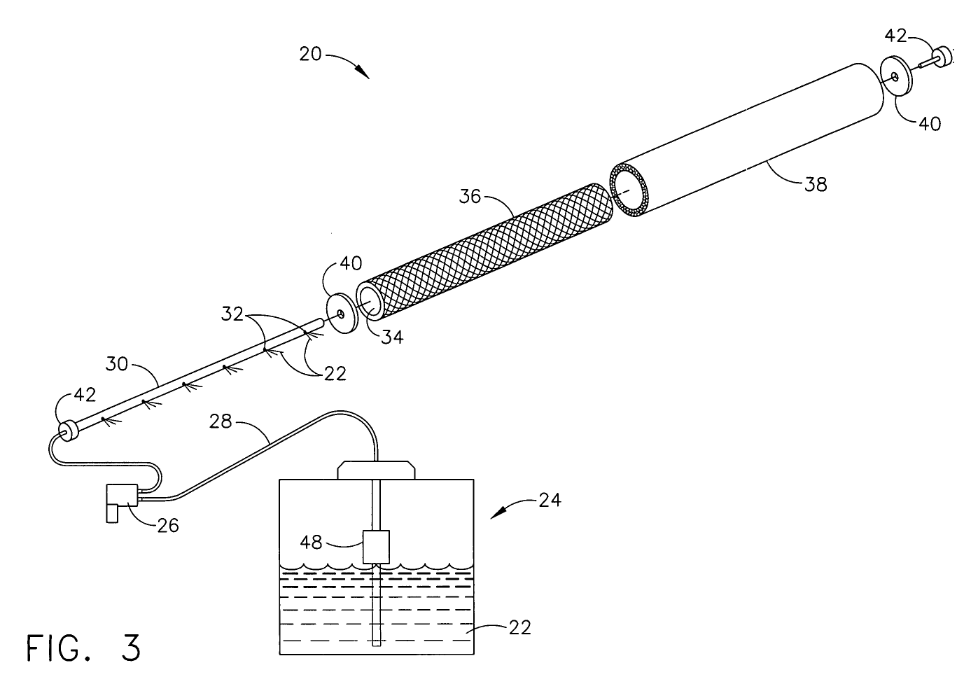

Continuing with FIGS. 1 and 2, and referring also to FIG. 3, the solution 22 is pumped internally into the porous roller 20 and wicked onto the conveyor belt 12 to kill germs and bacteria, and to clean the surface of the belt 12. Specifically, a perforated rod 30 receives the cleaning and sanitizing solution 22 from the pump 26. The rod 30 has a plurality of perforations 32 which can release the solution 22 after the rod 30 is inserted into a hollow interior 34 of the porous roller 20. The cleaning and sanitizing solution 22 which is wicked out the perforations 32 of the rod 30 is evenly distributed through the porous roller 20.

It is desirable for the porous roller 20 to have sufficient stiffness as well as porosity to perform its specified purpose. The roller 20 may therefore be formed of a single, porous material, if such porous material has sufficient structure to operate in accordance with the present invention. Alternatively, without departing from the scope of the invention, the roller 20 may be comprised of multiple layers, as illustrated in FIG. 3. In accordance with one embodiment of the present invention, the multiple layers of the porous roller 20 comprise a mesh interior 36 and a dispersion cover 38 disposed over the mesh interior 36. Since the dispersion cover 38 is similar to a sponge in function and texture, and therefore a typically weak and unformed layer, the mesh interior 36 provides some structure to the porous roller 20. The arrangement illustrated in FIG. 3 allows the solution 22 to flow through the structured mesh interior 36 into the permeable dispersion cover 38, resulting in application of an accurate, even, but not excessive, quantity of solution to the belt. Furthermore, providing structure to the porous roller allows the roller 20 to also remove debris, spilled fluids, and bacteria from the conveyor belt. Of course, it will be obvious to those skilled in the art that the mesh interior 36 and the dispersion cover 38 can comprise the same, single, material, if such a material can provide the porosity and structure contemplated by the present invention. End washers 40 and end caps 42 can be used to allow the roller 20 to roll uninhibited and concentrically while in operation.

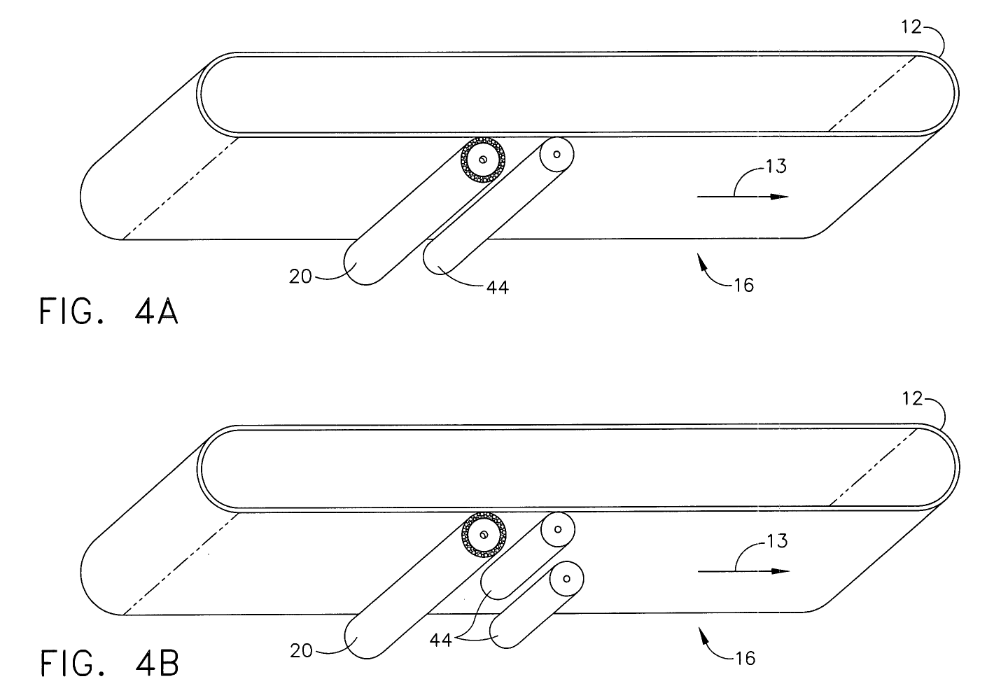

Referring again to FIG. 1, and also to FIGS. 4A and 4B, one or more drying rollers 44 can be disposed subsequent to application of the cleaning and sanitizing solution 22 to the conveyor belt 12. For example, a pair of drying rollers is illustrated in FIGS. 1 and 4B, whereas a single drying roller is illustrated in FIG. 4A, The drying roller or rollers 44 can expedite drying of the belt 12, as well as promote removal of stubborn debris, spills and undesirable fluids from the belt surface, thereby providing a clean and dry belt surface for use by a customer at the check stand. Hence, the number of drying rollers could be selected based on, for example, the speed of the belt, the distance of travel of the belt, or the width of the belt. If multiple drying rollers are used, the drying rollers 44 can be staggered or offset from one another, as illustrated in FIG. 4B, for additional removal of particulate matter, as well as more efficient drying of the belt surface.

Continuing with FIGS. 1 and 2, a collection tray 46 can be installed below the rollers for collecting debris, particulate matter, and fluid spills being removed from the belt. Unlike with prior art systems, such a tray would not fill with the cleaning solution, since the present invention meters the proper amount of fluid disposal without creating excess fluid.

It is anticipated that further embodiments of the present invention could include a variety of monitoring means. For example, a fluid monitoring means 48 can be used to monitor the fluid level in the reservoir 24. When the cleaning and sanitizing solution is depleted to a certain level, a signal can indicate that the tank 24 needs to be refilled, preventing the system 10 from running out of solution 22. The fluid monitoring means may be any suitable mechanical or electronic means, including, for example, a simple float.

Finally, system 10 can further comprise a self-diagnosis means 50 which can monitor the system 10 and send a signal for a variety of indications, such as maintenance needs. The self-diagnosis means 50 can monitor the fluid monitoring means 48 via line 52, to send the signal when more solution 22 is needed. Similarly, the amount of solution provided to the pump 26 and the perforated rod 30 can be metered via line 54, to ensure that rod 30 has sufficient solution to wick through the porous roller 20. The roller 20 might need more solution due to continuous use, which can be monitored by the self-diagnosis means 50, but also due to being in an idle mode for some period of time. Consequently, to more efficiently monitor the amount of solution for the system 10, a counter 56 as illustrated in FIG. 1, can be included with the system 10 to count the revolutions of the conveyor belt 12, via line 58. The counter 56 can indicate whether the conveyor belt is in use, or is in idle mode, and direct the pump to respond as needed with so that solution 22 is properly dispensed based on the revolutions of the belt. The counter 56 can also indicate if proper function of the roller 20 is interrupted, and send a signal for maintenance. These signals might all be stored in the self-diagnosis means and checked periodically, or receive immediate attention by being provided via internet lines, for example, to a maintenance center computer.

With the stated purpose of the present invention being to clean and sanitize a conveyor belt, it will be obvious to those skilled in the art that there are multiple ways of carrying out the purpose without departing from the scope of the invention. For example, an ultraviolet light can be applied to the conveyor belt to kill bacteria on the surface of the belt. Such a process could be applied continuously or at regular intervals, in association with the cleaning and sanitizing system and method already described herein. The system could be programmed to turn on the ultraviolet light whenever the conveyor belt is moving, with the ultraviolet light being applied at any stage of the cleaning and sanitizing process.

Having described the invention in detail and by reference to preferred embodiments thereof, it will be apparent that other modifications and variations are possible without departing from the scope of the invention defined in the appended claims.

What is claimed is:

1. A conveyor belt cleaning system for cleaning a continuous loop conveyor belt having an exposed surface for receiving and transporting items to a check stand, and an obscured surface region when the conveyor belt loops back around to become the exposed surface, the conveyor belt cleaning system comprising: a hollow porous roller disposed in the obscured surface region for providing debris removal and sanitization to the obscured surface, and a perforated rod inserted into the hollow porous roller, said perforated rod containing a cleaning and sanitizing solution, whereby the perforated rod evenly distributes the cleaning and sanitizing solution outwardly through the hollow porous roller to apply the cleaning and sanitizing solution to the conveyor belt while removing debris and bacteria from the conveyor belt without excess solution.

2. The conveyor belt cleaning system as claimed in claim 1, further comprising at least one drying roller for contacting the obscured surface of the conveyor belt subsequent to application of the cleaning and sanitizing solution to the conveyor belt in order to expedite removal of any fluids from the belt, thereby providing a clean and dry belt surface for use by a customer at the check stand.

3. The conveyor belt cleaning system as claimed in claim 1, further comprising a collection means situated below the hollow porous roller for collecting debris and particulate matter removed from the conveyor belt.

4. The conveyor belt cleaning system of claim 1 further comprising a pump means for dispensing cleaning and sanitizing solution to the perforated rod.

5. The conveyor belt cleaning system of claim 4 wherein the pump means further comprises a reservoir for holding solution before the solution is dispensed to the perforated rod.

6. The conveyor belt cleaning system of claim 5, further comprising a fluid monitoring means for monitoring the solution level in the reservoir.

7. The conveyor belt cleaning system of claim 6 further comprising a means for metering the amount of solution applied to the conveyor belt to prevent excess solution and solution waste.

8. The conveyor belt cleaning system of claim 7 wherein the pump means meters the amount of solution to dispense to the perforated rod based on conveyor belt usage.

9. The conveyor belt cleaning system of claim 8 further comprising a controller means for monitoring revolutions of the conveyor belt and controlling how long the pump means operates based on the revolutions, thereby providing precise solution distribution to the conveyor belt.

10. The conveyor belt cleaning system of claim 1 further comprising a system monitoring means for self-diagnosis of the cleaning system.

11. The conveyor belt cleaning system of claim 10 further comprising a signal means for indicating maintenance needs of the system, based on the system monitoring means self-diagnosis.

12. A method for cleaning and sanitizing a continuous loop conveyor belt having an exposed surface for receiving and transporting items to a check stand, and an obscured surface region when the conveyor belt loops back around to become the exposed surface, the conveyor belt cleaning method comprising the steps of:
situating a hollow porous roller in the obscured surface region for providing debris removal and sanitization to the obscured surface; and
inserting a perforated rod into the hollow porous roller, said perforated rod containing a cleaning and sanitizing solution, whereby the perforated rod evenly distributes the cleaning and sanitizing solution outwardly through the hollow porous roller to apply the cleaning and sanitizing solution to the conveyor belt while removing debris and bacteria from the conveyor belt without excess solution.

13. A method as claimed in claim 12, further comprising the step of providing at least one drying roller for contacting the obscured surface of the conveyor belt subsequent to application of the cleaning and sanitizing solution to the conveyor belt in order to expedite removal of any fluids from the belt thereby providing a clean and dry belt surface for use by a customer at the check stand.

14. A method as claimed in claim 12, further comprising the step of situating a collection means below the hollow porous roller for collecting debris and particulate matter removed from the conveyor belt.

15. A method as claimed in claim 12 further comprising the step of providing a pump means for dispensing cleaning and sanitizing solution to the perforated rod, said pump means having a reservoir for holding solution before the solution is dispensed to the perforated rod.

16. A method as claimed in claim 15, further comprising the steps of:
monitoring the solution level in the reservoir; and
using the monitoring to meter the amount of solution applied to the conveyor belt to prevent excess solution and solution waste.

17. A method as claimed in claim 16 further comprising the steps of:
monitoring revolutions of the conveyor belt; and
controlling how long the pump means operates based on the revolutions, thereby providing precise solution distribution to the conveyor belt.

18. A method as claimed in claim 12 further comprising the step of providing a system monitoring means for self-diagnosis of the cleaning system.

19. A method as claimed in claim 18 further comprising the step of providing a signal means for indicating maintenance needs of the system, based on the system monitoring means self-diagnosis.
